(19) United States
(12) Patent Application Publication
(10) Pub. No.: US 2013/0211872 A1
(43) Pub. Date: Aug. 15, 2013

(54) Assessing Risk Associated with a Vendor

(71) Applicants: William Jay Cherry, Sartell, MN (US); Cheryl Patton, Sauk Rapids, MN (US); John Nokes, Austin, TX (US); Darren Keith Brittain, Weston, FL (US)

(72) Inventors: William Jay Cherry, Sartell, MN (US); Cheryl Patton, Sauk Rapids, MN (US); John Nokes, Austin, TX (US); Darren Keith Brittain, Weston, FL (US)

(21) Appl. No.: 13/584,228

(22) Filed: Aug. 13, 2012

Related U.S. Application Data
(60) Provisional application No. 61/523,289, filed on Aug. 13, 2011.
(60) Provisional application No. 61/523,843, filed on Aug. 16, 2011.

(51) Int. Cl. G06Q 10/06

(52) U.S. Cl. CPC G06Q 10/0635
USPC 705/7.28

(57) ABSTRACT

There is disclosed a method and apparatus for assessing risk associated with a vendor. The method includes receiving vendor information from a vendor, the vendor information including uniquely identifying data, acquiring a first data set associated with the vendor from a third party and acquiring a second data set including a history of transactions with the vendor. The method further includes aggregating the vendor information, the first data set and the second data set into a vendor collective data set and identifying a risk factor using the vendor collective data set.

### RELATED APPLICATION INFORMATION

This patent claims priority from the following provisional patent applications:

U.S. Provisional Patent Application No. 61/523,289 entitled Accounts Payable Recovery Auditing filed on Aug. 13, 2011.

U.S. Provisional Patent Application No. 61/523,843 entitled Accounts Payable Recovery Auditing filed on Aug. 16, 2011.

This patent is also related to Patent Cooperation Treaty application no. ______ entitled “Accounts Payable Auditing and Risk Assessment” filed on Aug. 13, 2012.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to assessing risk associated with a vendor.

2. Description of the Related Art

Large-scale corporate and non-profit entities often deal with a multiplicity of vendors for services, products, consulting and various other corporate needs. The processes used to vet and incorporate new vendors may be rigorous or may be ad-hoc. In some cases, there may be a large number of satellite offices or smaller locations away from an individual charged with making payments for services, products, consulting or other corporate needs. In such situations, the individual responsible for paying may have no information available to evaluate an account payable for fraud, for inaccuracy or to evaluate the services prior to paying. The responsible individual may not even be able to easily contact the individual or unit, for example, for whom the services were rendered before payment is due.

As a result, these corporate and non-profit entities have tended to rely upon other, large vendors for these services, products, consulting and other corporate needs in order to limit the total number of vendors in an effort to reduce risk. However, sometimes, those large vendors are not available in every location or do not serve all of the entity's needs. Similarly, this does not stop larger-scale fraud, inaccuracy or evaluation failures. Large-scale entities desire a way to evaluate each vendor, large or small, and to quickly perform accounts payable auditing and to derive relevant risk assessment for that vendor.

### DESCRIPTION OF THE DRAWINGS

FIG. 1 is a diagram of an accounts payable auditing and risk assessment system.

FIG. 2 is a diagram of a computing device.

FIG. 3 is a diagram of an accounts payable auditing and risk assessment system.

FIG. 4 is a flowchart of vendor authentication.

FIG. 5 is an example of a risk assessment report.

FIG. 6 is a flowchart of accounts payable auditing.

FIG. 7 is an example of an audit report.

FIG. 8 is a flowchart of risk detection and assessment.

FIG. 9 is an example of a weighted risk score report.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Description of Apparatus

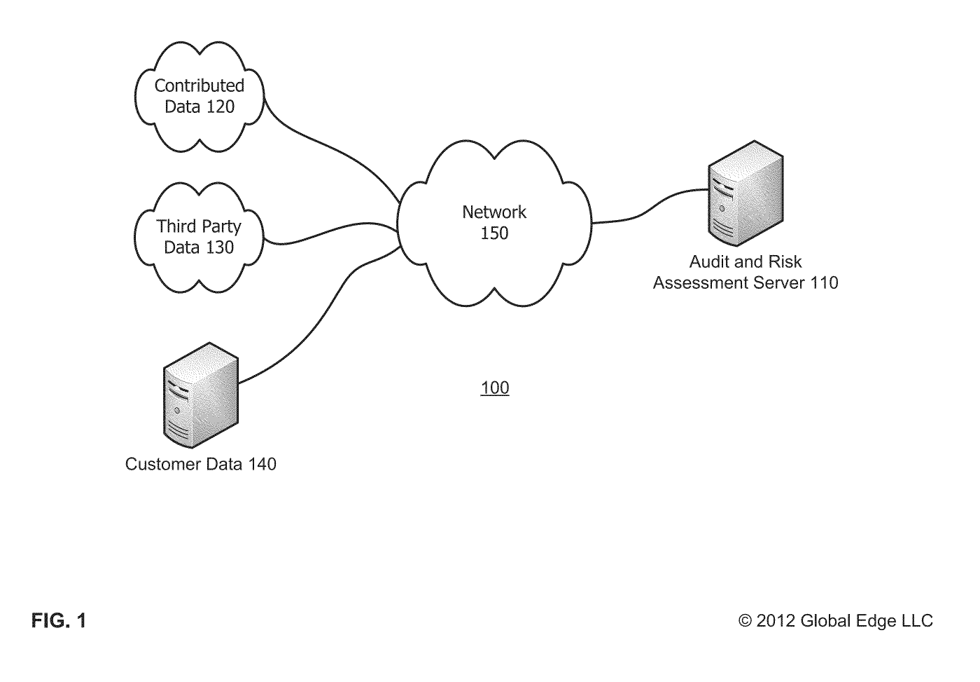

Referring now to FIG. 1, an accounts payable auditing and risk assessment system 100 is shown. The system 100 includes an audit and risk assessment server 110, contributed data 120, vendor data 130 and customer data 140 interconnected via a network 150.

The server 110 is connected to the network 150. The server 110 is shown as a computer, but may take many forms. The server 110 may be a personal computer, lap-top computer, mobile device, a tablet PC, a personal digital assistant, a smartphone, a “dumb” phone, a feature phone, a server computer operating as a part of a distributed or peer-to-peer network or many other forms.

For purposes of this patent, the term “vendor” as used herein means an individual or entity that requests payment from a customer for a a product, service, consulting or other needs. The term “customer” as used herein means an individual or entity from whom payments for a product, service, consulting or other needs are received.

The contributed data 120 is data provided to the server 110 by a vendor or generated by a customer as a part of the initiation of the relationship with the vendor. For example, the contributed data 120 may include data input directly by a vendor such as their own address or legal name. The contributed data 120 may also include data generated by the customer in initiating the relationship, such as the initiating individual who selected the vendor and relationships between the initiating individual and the vendor (or employees of the vendor). The contributed data 120 is shown as a “cloud” or network because it may be data derived from a number of sources, both in and outside of an organization.

The vendor data 130 is data provided to the client 110 that is generated about a vendor by a third party. Access to this data may be gated by passwords, fees or other systems. Examples of this type of data include individual or business credit scores, government documents, financial reports, financial evaluations and other, similar, data.

The network 150 may take the form of a local network, a wide area network, the Internet or any number of other networks. The network 150 may be implemented locally by physically connected computers or may be distributed over a wide area.

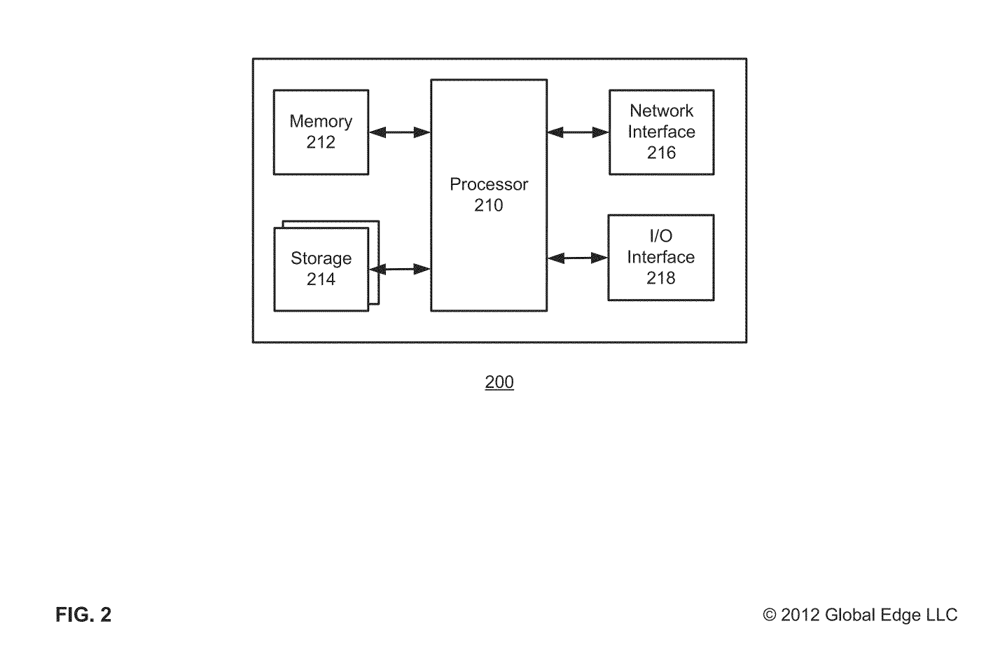

Turning now to FIG. 2, there is shown a computing device 200, which is representative of the server computers, client devices, mobile devices and other computing devices discussed herein. The computing device 200 may include software and/or hardware for providing functionality and features described herein. The computing device 200 may therefore include one or more of logic arrays, memories, analog circuits, digital circuits, software, firmware and processors. The hardware and firmware components of the computing device 200 may include various specialized units, circuits, software and interfaces for providing the functionality and features described herein.

The computing device 200 has a processor 210 coupled to a memory 212, storage 214, a network interface 216 and an I/O interface 218. The processor may be or include one or more microprocessors, application specific integrated circuits (ASICs), programmable logic devices (PLDs) and programmable logic arrays (PLAs).

The memory 212 may be or include RAM, ROM, DRAM, SRAM and MRAM, and may include firmware, such as static data or fixed instructions, BIOS, system functions, configuration data, and other routines used during the operation of the computing device 200 and processor 210. The memory 212 also provides a storage area for data and instructions associated with applications and data handled by the processor 210.

The storage 214 provides non-volatile, bulk or long term storage of data or instructions in the computing device 200. The storage 214 may take the form of a disk, tape, CD, DVD, or other reasonably high capacity addressable or serial storage medium. Multiple storage devices may be provided or available to the computing device 200. Some of these storage devices may be external to the computing device 200, such as network storage or cloud-based storage. In this patent, the term “storage medium” does not encompass transient media such as signals and waveforms that convey, but do not store information.

The network interface 216 includes an interface to a network such as network 150 (FIG. 1).

The I/O interface 218 interfaces the processor 210 to peripherals (not shown) such as displays, keyboards and USB devices.

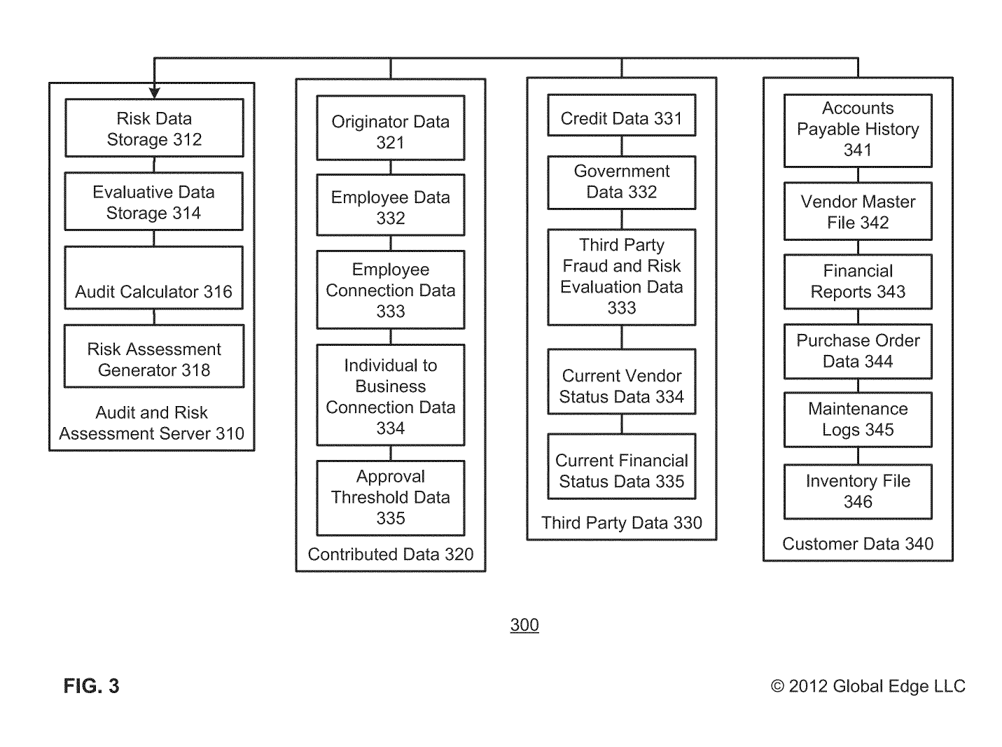

Turning now to FIG. 3, a diagram of an accounts payable auditing and risk assessment system 300 is shown. The system 300 includes an audit and risk assessment server 310, contributed data 320, third party data 330 and customer data 340. Each of the contributed data 320, the third party data 330 and the customer data 340 may be or include a “data set.”

The server 310, which may be server 110 above, includes risk data storage 312, evaluative data storage 314, an audit calculator 316 and a risk assessment generator 318.

The risk data storage 312 stores vendor data received as or from the contributed data 310, the third party data 330 and the customer data 340 so that it may be evaluated by the system 300.

The evaluative data storage 314 stores evaluative data, such as thresholds, percentiles, algorithms, formulas and data-mining routines used to evaluate the vendor data stored in the risk data storage 312.

The audit calculator 316 uses the vendor data in the risk data storage 312 and the evaluative data in the evaluative data storage 314 to perform accounts payable auditing. Accounts payable auditing is designed, among other things, to identify accounts payable discrepancies or issues that may be the result of fraud by a vendor.

The risk assessment generator 318 uses the vendor data, the evaluative data and the results of any accounts payable auditing to generate a risk assessment or risk analysis including a risk index.

The contributed data 320 includes five categories of contributed data. These are originator data 321, employee data 322, employee connection data 323, individual to business connection data 324 and approval threshold data 325. Additional categories of contributed data 320 may be included, so long as the contributed data 320 is data that is generated either by a vendor at the request of a customer or by the customer during or as a part of the initiation of the relationship with the vendor.

The originator data 321 is data pertaining to the customer individual or group (the “originator”) that originated and/or approved the vendor selection and/or identification. Originator data may be, for example, the name of an individual who suggested a vendor, selected a vendor, signed a purchase order with a vendor or otherwise initiated the relationship with the vendor.

The employee data 322 is information identifying or pertaining to a customer employee. This data may include, for example, as home address, telephone numbers, email addresses, spouses' name, children names, past employers and other, similar data.

The employee connection data 323 is data pertaining to customer employees. For example, this data 323 may be or include data pertaining to familial, professional, or personal relationships for each employee of a customer and/or vendor. This data 323 may include professional or non-profit group membership information. This data 323 may be input by the employee as a part of joining the company or of initiating a new vendor relationship.

The individual to business connection data 324 is data identifying any connections between an originator and any potential vendors. This data 324 may include, for example, information indicating that an originator was previously employed by or is related to a current or past employee of one or more companies who may become or already be vendors.

Approval threshold data 325 is data identifying a numerical value that each employee of customer may authorize. That numerical value is an approval threshold. For example, an originator may be authorized to obtain vendor services up to $5,000, but no more.

Third party data 330 includes credit data 331, government data 332, third party fraud and risk evaluation data 333, current vendor status data 334 and current financial status data 335. Third party data 330 is data pertaining to a vendor that is created or updated by a party other than the customer or the vendor. The third party that creates or updates the data 330 may charge a fee or require other information in order to access the data. Additional categories of third party data 330 may be included, so long as the third party data 330 is data that is generated by a third party and pertaining to a vendor

The credit data 331 is data pertaining to the creditworthiness of the vendor. If the vendor is an individual, this may be an individual credit report. If the vendor is an entity, this may be a so-called “business credit report,” stock rating, bond rating, or similar third-party-compiled financial information.

The government data 332 is data pertaining to the vendor that is generated or required by government entities. For example, this government data 332 may be a Securities and Exchange Commission filing in the case of a vendor that is a public company. This data 332 may be a tax return for a vendor that is an individual. This data may be sector-related such as the Bureau of Labor and Statistics data pertaining to a sector in which the vendor is involved.

The third party fraud and risk evaluation data 333 is one or more reports or other data identifying fraud or financial or other risk associated with a vendor and that is prepared by a third party. This data 333 may be a financial report generated by a third party financial analysis entity such as the Better Business Bureau® Moody's® or D&B Credibility® identifying instances of actual or suspected fraud or risks associated with a vendor or a vendor sector.

The current vendor status data 334 is one or more reports indicating the current financial or corporate status of the vendor. This may be, for example, current corporate registration statement (if available) or an indication that a vendor is entitled to conduct business in a given state.

The current financial status data 335 is one or more reports indicating the current financial status of the vendor. This may be Securities and Exchange Commission filings in the case of public companies. In non-public companies, this data may be financial summaries or estimates provided by the vendor or compiled by third parties.

Customer data 340 includes accounts payable history 341, vendor master file 342, financial reports 343, purchase order data 344, maintenance logs 345 and an inventory file 346. Customer data 340 is data pertaining to an on-going relationship with a vendor that is created as a part of the process of dealing with a vendor. Additional categories of customer data 340 than those identified here may be included.

The accounts payable history 341 is the record of the accounts payable ledger pertaining to at least one vendor. The accounts payable history 341 may include all payments requested and all payments made to one or more vendors.

The vendor master file 342 is the file containing all relevant payment information for one or more vendors. The file 342 includes, at least, the name and address of at least one vendor, but may include wire transfer or other direct payment information. It may also include a name and contact information for the payment processor at one or more vendors.

The financial reports 343 are the financial reports, such as balance sheet, cash flow statement, income statement and other financial reports, of the customer.

The purchase order data 344 are a record of purchase orders made to at least one vendor. These may include purchase order numbers, amounts, products or services associated with those purchase orders, the individual authorizing the purchase orders and similar information.

The maintenance logs 345 are a record of maintenance to buildings, fixtures and landscape associated with the customer. These logs 345 may identify maintenance done or repairs made, vendors used for the maintenance or repair, dates and times of maintenance and repairs, costs associated with the maintenance and repairs, the individual authorizing the maintenance or repairs and similar maintenance information.

The inventory file 346 is a record of inventory status for the customer. The inventory file 346 may include a periodic or real-time inventory of all products, business supplies or products (such as pencils, pens, paper, and the like) used by a customer. The inventory file may identify from which vendor those supplies were received, when they were received and at what cost.

These and other data sets may be incorporated into the risk data storage 312 of the audit and risk assessment server 310 for use in performing risk assessment and accounts payable auditing.

Description of Processes

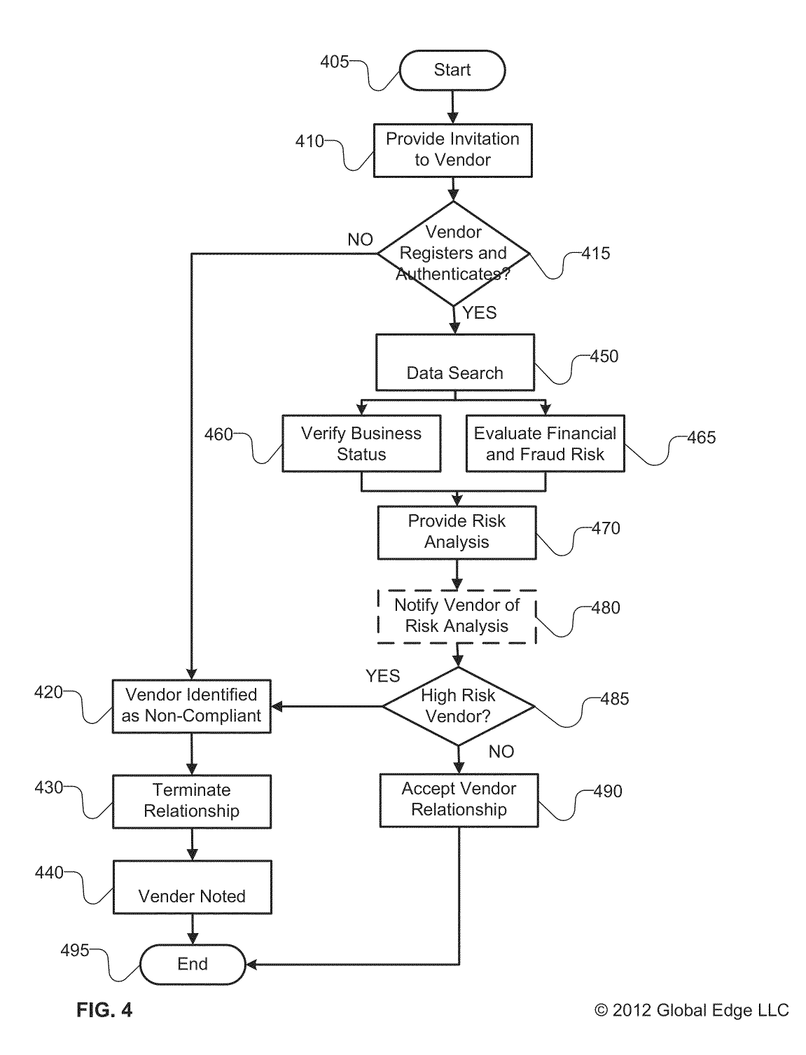

Referring now to FIG. 4, a flowchart, beginning at start 405, of vendor authentication is shown. First, a vendor is provided with an invitation to join the accounts payable auditing and risk assessment system at 410. This invitation may be sent to a vendor, for example, by a customer using an email, a web form, an application programming interface (API) or other system. The invitation may be, for example, a link to a web form or that launches a web-based or other application.

Next, the vendor registers and authenticates at 415. If the vendor refuses to register and authenticate, then the vendor is identified as non-compliant at 420, the customer-vendor relationship is terminated at 430 and the vendor may be noted at 440 as refusing to register and authenticate at 415 and/or as a high-risk vendor (see 485) and the process ends at 495. In some cases, a vendor known to be compliant or otherwise desired by a customer may be registered and authenticated at 415 by the customer using publically available data.

The registration and authentication process at 415 involves inputting vendor data. This may be in whole or in part the contributed data 320 identified in FIG. 3. As a part of this process, basic data pertaining to the processing of payments, the vendor address and other contributed data 320 is input by the user. One or more administrators are identified and a username and password or similar login credentials are created. Different processes, and thus different data, may be required for corporate vendors as opposed to individuals. Individuals may, as desired by a customer, be excluded from registering at all.

If the registration and authentication at 415 is successful, then a data search is performed at 450. In this process, contributed data 320, third party data 330 and customer data 340 (FIG. 3) are obtained.

Next, the business status is verified at 460. This process may use contributed data 320 and third party data 330 to confirm that the vendor is registered or otherwise authorized to operate in a given location. In addition, current tax liens, governmental investigations or other business status information may be verified to ensure that the entity is a viable, operating business in a given location.

Simultaneously, the financial and fraud risk of the vendor is evaluated at 465. This process may involve a comparison of contributed data 320, third party data 330 and customer data 340 in order to determine the likelihood of financial risk or that fraud is currently taking place. For example, the customer data 340 may be evaluated in order to determine whether there have been duplicate invoices or whether a series of above average payments have recently been made to a particular vendor. In situations in which no relationship with the vendor yet exists, this process may not take place.

A risk analysis is then generated at 470. This risk analysis is an indication whether a risk alert has been triggered by the verification of business status at 460 or financial and fraud risk evaluation at 465. The failure to generate a risk alert does not mean that no problems were detected, it merely means that no problems identified in the evaluative data stored in the evaluative data storage 314 or exceeding a predetermined or customer-set threshold have been found. If a risk alert is triggered, the vendor will be flagged or otherwise identified and the customer may automatically refuse the customer/vendor relationship or the vendor may be referred to an individual for further review before accepting the customer/vendor relationship.

Risk alert triggers may be customer-set or predetermined, for example, such that the vendor must be authorized to do business in the location where services are being provided. Alternatively, the risk alert triggers may require that a company name input by a vendor match a name or doing business as (DBA) on public records or that an employer tax ID number associated with a vendor individual match associated public records. Still further alternatively, the risk alert may indicate that one or more invoice numbers have been issued by a vendor or paid by the customer more than once. In some situations, a plurality of these errors may be acceptable, but two or more issues of any type or of a specific subset may surpass a collective threshold, thus triggering a risk alert.

The vendor may be notified of the risk analysis 480. This step is optional, shown in dashed lines. At this stage, the vendor may see the exact reason that the customer/vendor relationship was declined (or accepted). In other cases, the vendor may not be notified, so as to cut down on potential for gaming the system or overcoming the risk through surreptitious methods.

If a vendor is identified as a high risk vendor at 485, for example, when a risk alert is triggered, then the vendor is identified as non-compliant at 420, the relationship is terminated 430 and the vendor is noted 440 and the process ends at 495.

If the vendor is not identified as a high risk vendor at 485, then the vendor relationship is accepted at 490 and the process ends at 495.

The flow chart has both a start 405 and an end 495, but the process may be cyclical in nature and multiple instances of the process may be taking place simultaneously.

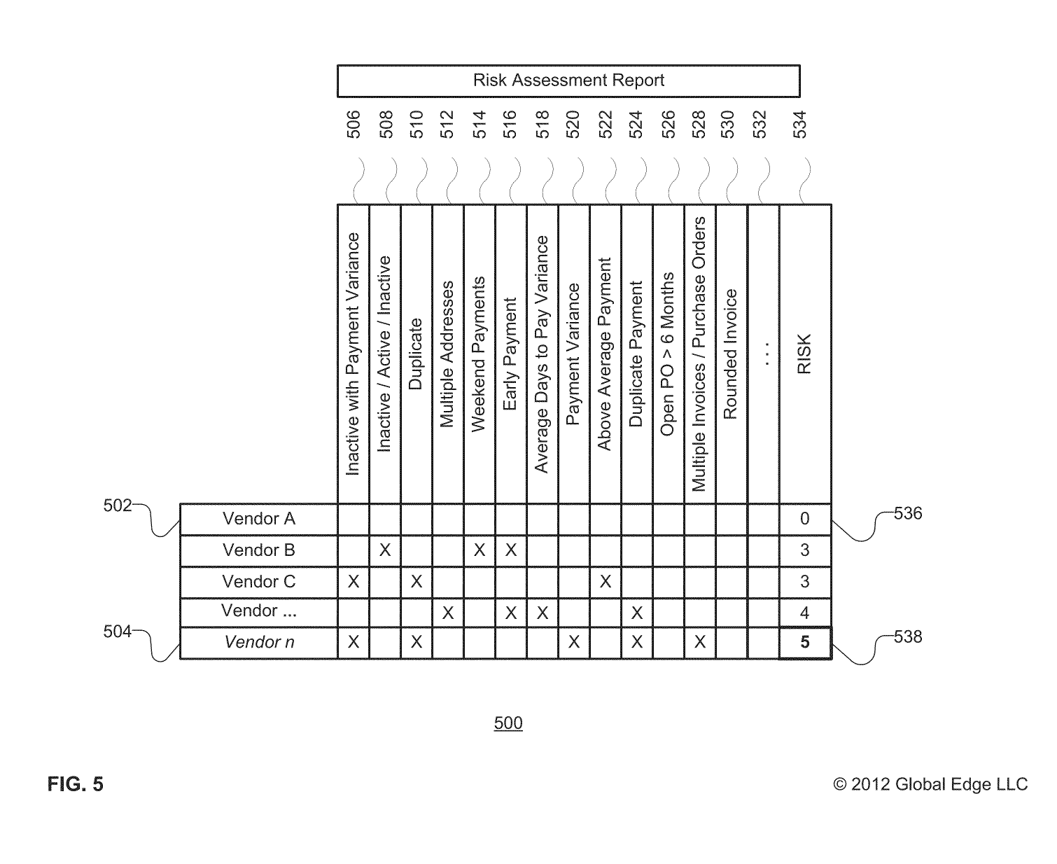

FIG. 5 is an example of a risk assessment report 500. The risk assessment report 500 (or risk analysis) identifies a plurality of vendors, such as vendor A 502 and vendor n 504 and a plurality of risk factors 506-532, a risk total 534 in addition to risk numbers 536 and 538 (which may identify a vendor risk). The phrase “risk factor” as used herein means at least one contributed data 320, third party data 330 or customer data 340 (FIG. 3) that tends to suggest that a vendor may pose a financial risk to a customer.

In this report 500, vendor A 502 has zero risk factors and, as such, has a risk number 536 of “0.” In contrast, vendor n 504 has five different risk factors 506, 510, 520, 524 and 528 and, therefore, has a risk number 538 of “5.” This risk number 538 is presented in “bold” to thereby indicate that a risk alert has been generated by this risk number 538. This risk alert for risk number 538 indicates that this vendor may pose a risk for the customer.

The risk factors 506-532 are indicators of potential vendor risk. These are a plurality of non-exclusive factors that may, alone or in combination with one another, indicate a vendor risk. Fewer or additional risk factors may be considered and shown in a risk assessment report 500.

The first is inactive with payment variance 506, indicating that a vendor is no longer an active entity registered with an appropriate governmental entity, and that that vendor has, in the past, had some payment issue. This may indicate that there is a financial issue with the vendor. The second is inactive/active/inactive 508 indicating that the vendor has been inactive, gone active and then returned to inactive with the appropriate governmental entity. This may indicate fraudulent intent, a change of ownership or other financial trouble with a vendor.

The next factor is duplicate 510 indicating that the same entity appears twice in governmental records and/or in a master vender list. This may demonstrate an attempt to confuse the customer as to the appropriate entity to pay for a product or service or may present potential for confusion and intentional or unintentional payments to the wrong entity.

The next factor is multiple addresses 512 indicating that the same vendor has input multiple addresses for payment or communication. This may suggest that some payments will be processed appropriately, while others will be misdirected to an individual. The next factor is weekend payments 514 indicating that the vendor has made payments to the customer on a weekend. This may suggest that someone other than the vendor is receiving those payments.

The next factor is early payment 516 indicating that a vendor has requested payments by the customer before they we were due, typically pre-payment by a certain threshold of days. This may suggest vendor financial distress. The next factor is an average days to pay 518 variance indicating that at least one payment is well outside (typically by a threshold of days either before or after) the average days taken to pay. This, also, may suggest an extra or unforeseen payment that may be fraudulent.

The next factor is a payment variance 520 indicating that a particular payment is different than a typical or average payment which may indicate that there is a problem with the vendor. The next factor is an above average payment 522 indicating that a payment is above an average payment, typically by a threshold amount. This may suggest that a false invoice was provided or that work has been double-billed.

The next factor is duplicate payment 524 indicating that the same payment or payment on the same invoice for a vendor has been made more than once. This is an instance in which repayment of the duplicate payment may be requested. The next factor is an open purchase order greater than 6 months 526 indicating that the customer has sent a purchase order that has not been filled for more than 6 months. This may demonstrate that a vendor is financially or otherwise unable to fulfill a purchase order.

The next factor is multiple invoices or purchase orders 528 indicating that there are multiple outstanding invoices or purchase orders for a particular vendor. This, also, could demonstrate that a vendor is unable to fulfill a purchase order. The next is a rounded invoice 530 indicating that a particular invoice is a round number. This may indicate that a particular invoice has been fabricated. Other factors, such as risk factor 332 may also be considered.

These risk factors are totaled in the risk total 534 and, where thresholds of risk are exceeded, such as at risk number 538, risks alerts are noted in the risk assessment report. This may be through bolding, color-coding or other emphasis.

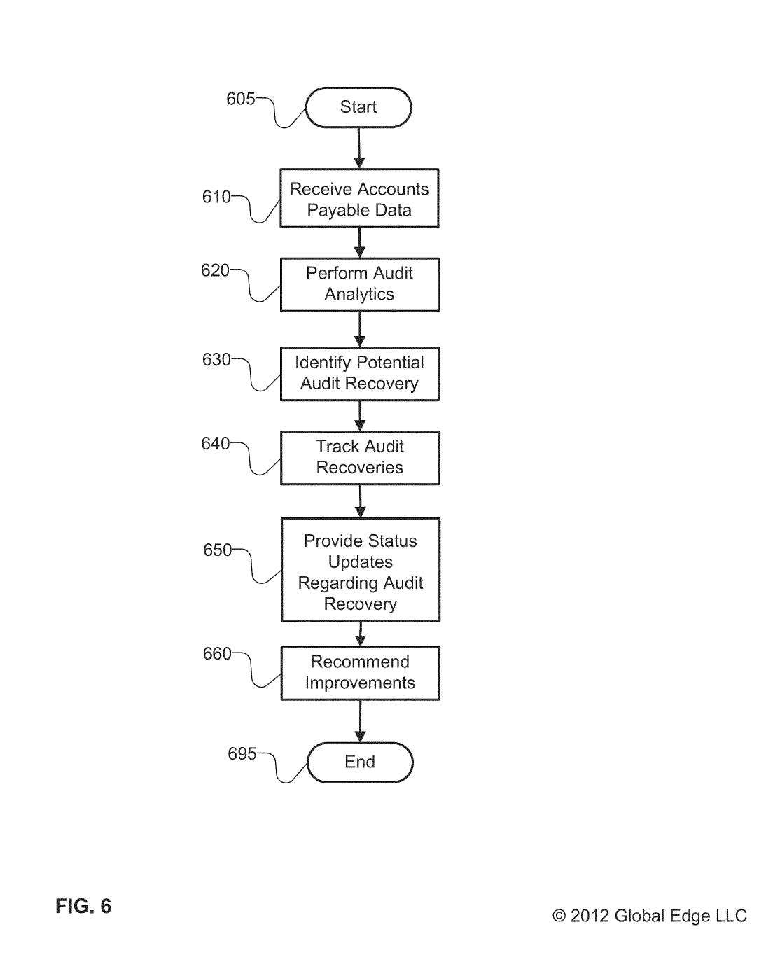

FIG. 6 is a flowchart, beginning at start 605, of accounts payable auditing. First, accounts payable data is received at 610. This data is, preferably, all accounts payable data for a customer that is available in a format suitable for computer evaluation. This format may be, for example, a spreadsheet, a database or an API interface to the server 310 that enables the server 310 to obtain the data through one or more API calls.

The accounts payable data may be or include the accounts payable history 341. At a minimum, the accounts payable data includes a record of payments made by a customer to a vendor. Preferably, the accounts payable data includes data pertaining to purchase orders, inventory received or services rendered, invoices received from one or more vendors and a record of payments associated with the purchase orders and invoices.

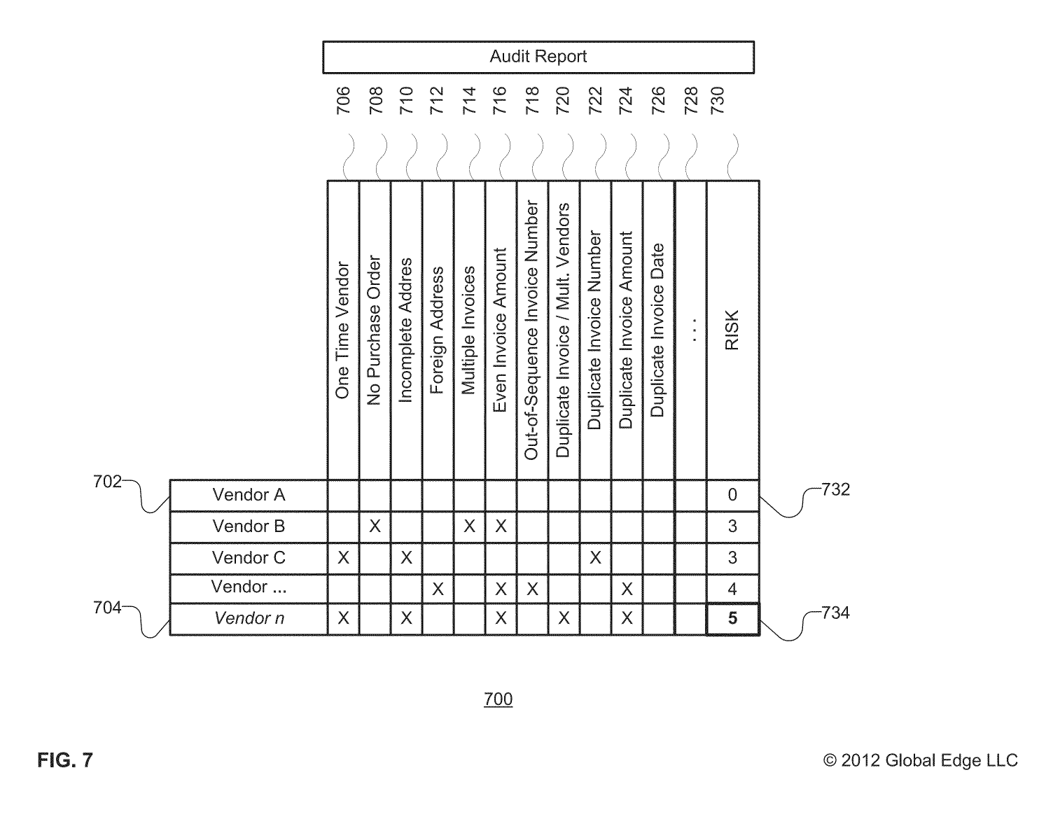

Next, audit analytics are performed at 620. The audit analytics are used to identify any potential risks associated with accounts payable. An example of an audit report appears in FIG. 7. The risks tracked through these audit analytics may include any one of the potential risks identified in FIG. 7, such as duplicate invoice numbers. These risks may be automatically identified by the server 310 using the accounts payable data provided at 610.

Once potential risks are identified, then a human researcher may confirm that the risk represents an actual overpayment, lack of credit, lack of discount or other accounts payable discrepancy. In so doing, the human assisted by the server 310 may identify potential audit recovery.

In some cases, no human intervention may be required. For example, analysis of the accounts payable data at 620 may indicate that a single invoice was paid twice by a customer. If the accounting systems between the customer and the vendor are interlinked, then the server 310 may automatically request a chargeback of the appropriate duplicate invoice. The chargeback may automatically include a description of the reason for the chargeback, namely the duplicate payment and identify all relevant information related to the chargeback such as the invoice number and date along with the dates and amounts of the duplicate invoice payments.

The system may be continuously updated with any new accounts payable data and, thus, be able to track audit recoveries at 640. This process may be or include the server 310 automatically identifying moneys returned to the customer through the accounts payable auditing processes and generating reports to reflect these results. Alternatively, this tracking at 640 may involve human interaction to identify specific moneys that were received outside of the normal accounts payable process, and to associate those moneys with the accounts payable auditing process.

Once this data is integrated into the server 310, the server 310 may provide status updates regarding the audit recovery process at 650. These status updates may include the reports created in response to receipt of accounts payable auditing. These status updates may also be or include recommendations of improvements at 660. For example, automated accounting interaction between a customer and a vendor will utilize all-digital purchase orders, invoices and payments that, typically, result in fewer accounts payable errors. Automated systems, also, are typically less prone to accounts payable fraud and, when they are used to commit fraud, typically leave more direct and permanent evidence of those committing the fraud. These and other improvements may be recommended as a part of the accounts payable auditing process.

FIG. 7 is an example of an audit report 700. The audit report 700, generated at 620 (FIG. 6) identifies a plurality of vendors, such as vendor A 702 and vendor n 704 and a plurality of risk factors 706-728, a risk total 730 in addition to risk numbers 732 and 734 (which may identify an audit risk).

Vendor A 702 in this report has no risk factors and, as such, has a risk number 732 of “0.” In contrast, vendor n 704 has five different risk factors 706, 710, 716, 720 and 724. As a result, the total of these is a risk number 734 of “5.” This risk number 734 is presented in “bold” to thereby indicate that a risk alert has been generated by this risk number 734. This risk alert for risk number 734 indicates that this vendor may pose a risk for the customer.

The risk factors 706-728 are a plurality of indicators of potential fraud risk. Specifically, these risk factors 706-728 may be, alone or in combination, indicators of potential fraud in accounts payable for a particular customer. The risk factors shown are merely examples. Fewer or more risk factors may be included in an audit report 700.

The first risk factor is a one-time vendor 706. This means that a vendor received only one purchase order or service request and/or received a single payment. This could be an example of an employee of the customer using accounts payable to pay a friend for products and services that are not, in fact, rendered. Accordingly, it is a risk factor in accounts payable auditing.

The next risk factor is a payment with no corresponding purchase order at 708. This payment is likely to be a payment when no services have been rendered and, thus, is a potential risk factor in accounts payable auditing. The next factor is an incomplete address 710. This may indicate an intent to cause confusion as to the address for payment in order to intercept or otherwise surreptitiously act on a payment (such as claiming payment was not received when payment was received).

The next risk factor is a foreign address 712. Foreign addresses present problems when trying to seek reimbursement or may indicate an intent to receive payment and not provide services while leaving the customer with limited ability to respond. The next risk factor is multiple invoices 714 in which there are a plurality of invoices in rapid succession. This may indicate that the same work is being billed-for multiple times.

The next risk factor is an even invoice amount 716. This may indicate an invoice in which a round number was selected at random by a potentially fraudulent vendor. Another risk factor is an out-of-sequence invoice number indicating that an invoice was missing or skipped. This may suggest that someone other than the vendor sent the invoice or that an employee with less familiarity with the invoice process has requested payment, potentially for non-existent products or services.

The next risk factor is a duplicate invoice/multiple vendors 720 in which an invoice has been sent twice or that two vendors have billed for the same services or product. The next risk factor is duplicate invoice number 722 in which the same invoice has been sent twice, potentially to seek dual payments for one service or product.

The next risk factor is duplicate invoice amount 724 in which the invoice number is new, but the balances of both invoices are identical. This may suggest that a vendor is seeking dual payments for one service or product. Another risk factor is duplicate invoice date 726 in which more than one invoice was prepared and sent on the same day. This, again, may suggest an attempt to obtain duplicate payments. Other risk factors, such as risk factor 728 may also be used.

The risk total 730 is a total, for each vendor, of the risk factors identified. These risk factors may result in a risk alert. Risk number 732 is zero and, thus, no risk alert is generated in the report 700. Risk number 734 is 5 and, for example, may trigger a risk alert because it has exceeded a risk factor threshold, for example, of 4. In such an instance, the risk number 734 may be bolded or otherwise emphasized (as shown).

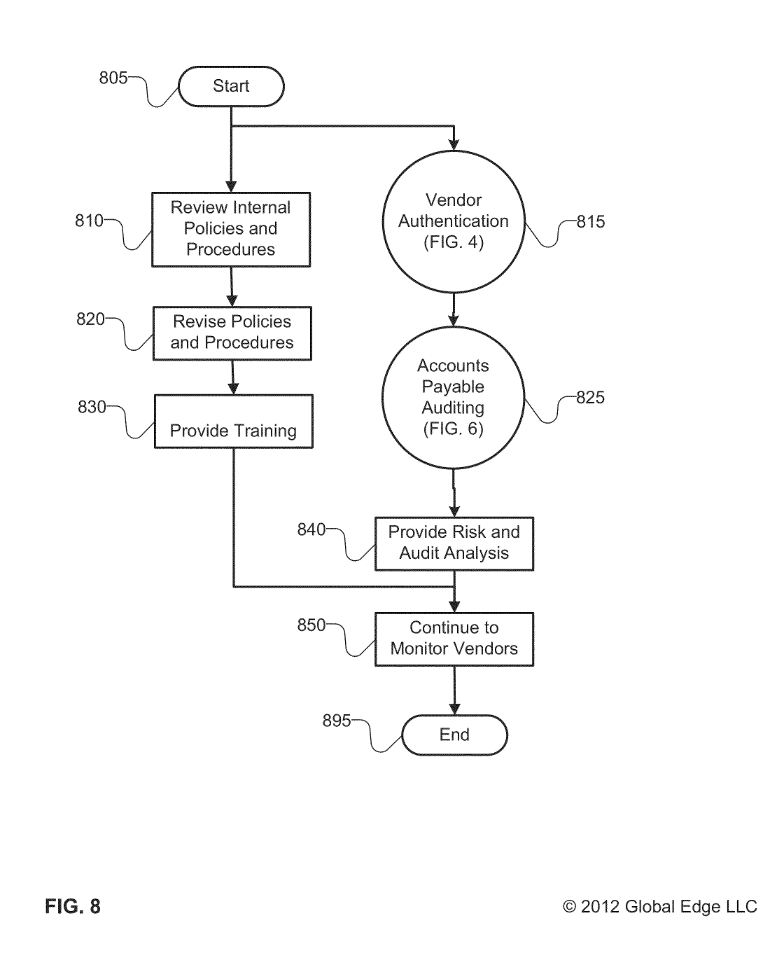

FIG. 8 is a flowchart, beginning at start 805, of risk detection and assessment. First, the internal policies and procedures are reviewed at 810. This process may require the interaction of one or more individual fraud analysts. This process may involve a review of any relationships between the vendor and customer employees using contributed data 320, accounting data, employee interviews and background investigations. This process may take place, in part, automatically, for example requesting background checks for one or more customer employees or categorizing or otherwise reviewing accounting.

Next, the policies associated with the customer/vendor relationship may be revised at 820 so as to automatically require the types of information reviewed at 810 to be collected at employee hire time or during the vendor risk assessment procedure. Training on these new policies may be provided at 830.

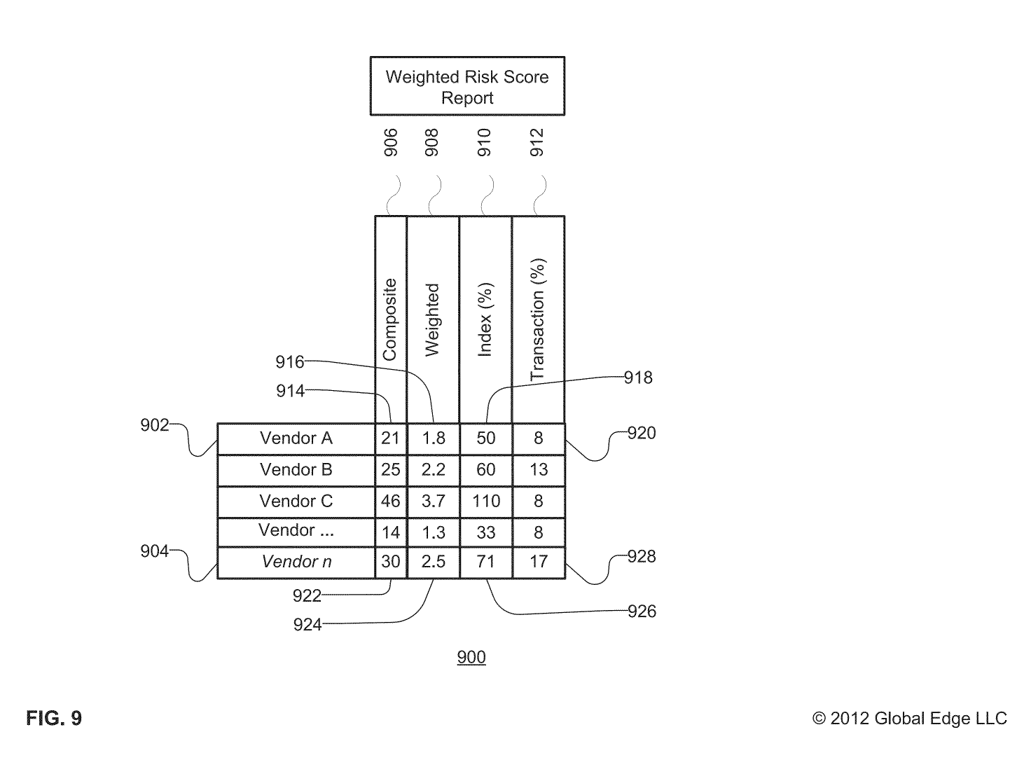

The vendor authentication at 815 may be completed as described above in FIG. 4 and the accounts payable auditing, described above with reference to FIG. 6 may be completed. Once complete, a risk and audit analysis may be provided to the customer at 840. This risk and audit analysis, such as the weighted risk score report shown in FIG. 9, identifies a vendor or vendors who have triggered risk alerts during the vendor authentication or accounts payable auditing and the risk alerts that have caused those vendors to be identified. The analysis may also be weighted so as to place emphasis on vendors who have particularly high risk and audit analysis scores.

Even after a risk assessment report is provided at 840 and the accounts payable auditing at 825 is completed, the same vendors continue to be monitored 850 in real-time such that any new risk alerts generated by the vendor authentication process at 815 or the accounts payable auditing at 825 are noted and, as necessary, new risk and audit analysis are provided.

FIG. 9 is an example of a weighted risk score report 900. The report 900 may be used as a part of or as a risk and audit analysis. The report identifies the same vendor A 902 and vendor n 904 shown in FIGS. 5 and 7. The report 900 includes a composite score 906, a weighted score 908 an index score 910 and a transaction score 912. The weighted score 908 may be called a “risk index.”

The composite score 906 is a sum of all the risk factors identified for a particular vendor. Vendor and audit risk factors are disclosed in FIGS. 4-7 in this patent, but additional factors may be considered. As additional factors, obtainable from data available to a customer are discovered, that data may be obtained and those factors may be incorporated into the risk and audit analysis.

The weighted score 908 is the composite score divided by the total possible risk factors that could have been identified multiplied by a weighting applied to each risk factor. For example, the duplicate invoice amount 724 (FIG. 7) may have been identified by the system. A weighting is assigned to that risk factor of, for example, 3.6. Alternatively, weighting may be assigned to a risk total for vendor risk, fraud risk or another category of risk. Assuming a single weight were applied to all risk factors in composite score 914 of 21, and assuming the total available risk factors were 42, then the weighting of the composite score would be 3.6, such that 21/42*3.6=1.8, the weighted score 916.

A weighting is preferably used for each risk factor individually. A different weighting may be applied or may be multiplicatively or exponentially applied as the number of instances of a particular risk factor increase. For example, if a vendor has only one duplicate invoice, a small weight may be applied to that risk factor. However, if a vendor appears to have a growing number of duplicate invoices, the weighting applied to that risk factor may increase as more and more duplicate invoices are discovered.

Similar weighting and associated logic may be applied to any individual or group of risk factors. For example, weighting may be applied in such a way that when more than three duplicate invoices are found from a vendor and the vendor has provided multiple addresses for payment, a much higher weight is applied to both risk factors or only to one risk factor than when either appears individually in a risk and audit analysis. Accordingly, multiple thresholds on multiple risk factors may be used simultaneously, to better identify potential risk or fraud.

Still further alternatively, a single instance of one risk factor along with a single instance of another risk factor may be considered together so as to alter the weighting associated with one or both of those risk factors.

The index score 910 is the total percentage, of available risk factors for a vendor, that were present for that vendor. Stated another way, the index score is the composite score divided by the total number of available risk factors for a vendor. For a given vendor data may not be complete such that some risk factors that would preferably be evaluated may not be evaluated. When that happens, the total number of available risk factors for a vendor is fewer. So, for example, vendor A 902 has a composite score 914 of 21. For vendor A, there were a total of 42 risk factors available for analysis, so the resulting index score is 21/42=50%, the index score 918.

The transaction score 912 is the total percentage of transaction exceptions divided by the total number of transactions with a vendor. So, for example, if vendor A had a total of 100 purchase orders, invoices, payments and other transactions with a customer and, of those 100, 8 individual transactions were identified as having potential issues, the transaction score 912 would be 8/100=8%, the transaction score 920. A high percentage of potential issues may, for example, demonstrate intentionally fraudulent activity. A low percentage of potential issues may demonstrate unintentional activity.

So, for vendor n, the composite score 922 of 30 is divided over the total number of available risk factors, 42, to calculate the index score 926 of 71%. Next, we can calculate the weighted score, using an example in which the entire composite score of 30 is weighted at a factor of 3.57 (typically each risk factor would be weighted individually and, potentially, with reference to another risk factor) to determine that the weighted score 924 is a 2.5. The transaction percentage 928 for vendor n is 17% meaning that, of an example 100 transactions, 17 of those transactions were identified with potential issues.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method for assessing risk associated with a vendor comprising:
receiving vendor information from a vendor, the vendor information including uniquely identifying data;
acquiring a first data set associated with the vendor from a third party using the uniquely identifying data;
acquiring a second data set associated with the vendor, the second data set including a history of transactions with the vendor;
aggregating the vendor information, the first data set and the second data set into a vendor collective data set; and
identifying a risk factor using the vendor collective data set.

2. The method of claim 1 further comprising determining a transaction percentage for the vendor in which the risk factor is identified.

3. The method of claim 1 further comprising generating a risk index based upon the vendor collective data set, the risk index (1) weighted so as to place emphasis on a selected one of the vendor information, the first data set and the second data set and (2) including the transaction percentage.

4. The method of claim 1 further comprising determining that the vendor may be used by a customer based upon the risk index.

5. The method of claim 1, further comprising determining a probability of fraud for the vendor using the risk index.

6. The method of claim 5, further comprising tracking activity of the vendor.

7. The method of claim 1, further comprising analyzing the vendor collective data set so as to identify interrelationships.

8. The method of claim 1 wherein the risk factor is a determination that an interrelationship exists between the vendor and a second vendor.

9. The method of claim 1 wherein the risk factor is a determination that an interrelationship exists between the vendor and an employee of a customer.

10. Apparatus comprising a storage medium storing a program having instructions which when executed by a processor will cause the processor to:
receive vendor information from a vendor, the vendor information including uniquely identifying data;
acquire a first data set associated with the vendor from a third party using the uniquely identifying data;
acquire a second data set associated with the vendor, the second data set including payment history for the vendor;
aggregate the vendor information, the first data set and the second data set into a vendor collective data set; and
identify a risk factor using the vendor collective data set.

11. The apparatus of claim 10 wherein the program, when executed by the processor will further cause the processor to determine a transaction percentage for the vendor in which the risk factor is identified.

12. The apparatus of claim 10 wherein the program, when executed by the processor will further cause the processor to generate a risk index based upon the vendor collective data set, the risk index (1) weighted so as to place emphasis on a selected one of the vendor information, the first data set and the second data set and (2) including the transaction percentage.

13. The apparatus of claim 10 wherein the program, when executed by the processor will further cause the processor to determine that the vendor may be used based upon the risk index.

14. The apparatus of claim 10 wherein the program, when executed by the processor will further cause the processor to determine a probability of fraud for the vendor using the risk index.

15. The apparatus of claim 14, wherein the program, when executed by the processor will further cause the processor to track activity of the vendor.

16. The apparatus of claim 10, wherein the program, when executed by the processor will further cause the processor to analyze the vendor collective data set so as to identify interrelationships.

17. The apparatus of claim 10 wherein the risk factor is a determination that an interrelationship exists between the vendor and a second vendor.

18. The apparatus of claim 10 wherein the risk factor is a determination that an interrelationship exists between the vendor and an employee of a customer.

19. The apparatus of claim 10 further comprising:
a processor;
a memory;
wherein the processor and the memory comprise circuits and software for performing the instructions on the storage medium.
